(19) United States
(12) Patent Application Publication
(10) Pub. No.: US 2013/0251434 A1
(43) Pub. Date: Sep. 26, 2013

(54) IMAGE FORMING APPARATUS WITH CONVEYANCE SUSPENSION UNIT

(71) Applicants: Naoto UEDA, Ibaraki (JP); Makoto NAKURA, Ibaraki (JP); Shingo TAKAI, Ibaraki (JP); Satoshi UEDA, Ibaraki (JP); Koichi KUDO, Kanagawa (JP)

(72) Inventors: Naoto UEDA, Ibaraki (JP); Makoto NAKURA, Ibaraki (JP); Shingo TAKAI, Ibaraki (JP); Satoshi UEDA, Ibaraki (JP); Koichi KUDO, Kanagawa (JP)

(73) Assignee: RICOH COMPANY, LTD.

(21) Appl. No.: 13/833,805

(22) Filed: Mar. 15, 2013

(30) Foreign Application Priority Data
Mar. 23, 2012 (JP) 2012-067670
Mar. 8, 2013 (JP) 2013-046281

(51) Int. Cl. G03G 15/00

(52) U.S. Cl. CPC G03G 15/6558
USPC 399/388

(57) ABSTRACT

An image forming apparatus includes a drive roller configured to rotate, a driven roller configured to hold and convey a print medium at a gap between the drive and driven rollers, an image carrier configured to have a toner image formed on a surface thereof and to rotate, the image carrier being situated downstream relative to the drive roller and the driven roller in a travel direction of the print medium, a transfer roller configured to hold and convey, at another gap between the image carrier and the transfer roller, the print medium passed from the drive roller and the driven roller to transfer the toner image onto a surface of the print medium, and a conveyance suspension unit to stop the drive roller and the driven roller from applying a drive force to the print medium at a time at which the print medium reaches such another gap.

### BACKGROUND OF THE INVENTION

1. Field of the Invention

The disclosures herein relate to an image forming apparatus.

2. Description of the Related Art

An image forming apparatus may use a configuration that transfers a toner image formed on a photo conductor to an intermediate transfer belt. The toner image is then transferred onto a sheet that is placed between the intermediate transfer belt and a transfer roller situated in contact with the intermediate transfer belt. In this manner, a printout is obtained on which the image is printed.

At the time of transferring a toner image onto a sheet, the surface speed of the rotating intermediate transfer belt may differ from the speed of the sheet being conveyed. In such a case, the position of the toner image transferred from the intermediate transfer belt onto the sheet may be displaced. This may result in the misalignment of the image and uneven image density, which degrade image quality. Further, accuracy of alignment between a front-side image and a back-side image may be lowered in the case of duplex printing.

In consideration of the above, a torque limiter that transmits a drive force smaller than the torque generated by a physical contact between a transfer roller and an intermediate transfer belt is provided along the path that transmits a drive force between a drive unit for driving the transfer roller and the transfer roller (see Japanese Patent Application Publication No. 11-52757, for example).

With the configuration described above, the transfer roller rotates to follow the movement of the intermediate transfer belt, so that the surface speed of the intermediate transfer belt and the travel speed of a sheet can be kept equal to each other. This can avoid reduction in image quality caused by positional displacement occurring at the time of image transfer.

There is a need to provide an upstream conveyance unit at an upstream position relative to the intermediate transfer belt and the transfer roller to supply a sheet to the intermediate transfer belt and the transfer roller. In this configuration, the sheet is first conveyed by the upstream conveyance unit, and is then held both by the upstream conveyance unit and by the intermediate transfer belt and the transfer roller, followed by being passed to the intermediate transfer belt and the transfer roller.

When this happens, a difference between the sheet conveyance speed of the upstream conveyance unit and the sheet conveyance speed of the intermediate transfer belt and the transfer roller creates a pushing force or a pulling force applied by the upstream conveyance unit to the sheet which enters a gap between the intermediate transfer belt and the transfer roller. In this case, therefore, the surface speed of the intermediate transfer belt differs from the travel speed of the sheet, resulting in a positional displacement of an image or the like. Image quality may thus be degraded. Even with the configuration that causes the transfer roller to follow the movement of the intermediate transfer belt, the existence of a difference in conveyance speed caused by the upstream conveyance unit may degrade image quality.

Accordingly, there may be a need for an image forming apparatus that can produce a high-quality image by keeping the travel speed of a print medium equal to the surface speed of an image carrier at the time of transferring a toner image to the print medium.

### SUMMARY OF THE INVENTION

It is a general object of at least one embodiment of the present invention to provide an image forming apparatus that substantially obviates one or more problems caused by the limitations and disadvantages of the related art.

According to one embodiment, an image forming apparatus includes a drive roller configured to rotate, a driven roller configured to hold and convey a print medium at a gap between the drive roller and the driven roller, an image carrier configured to have a toner image formed on a surface thereof and to rotate, the image carrier being situated downstream relative to the drive roller and the driven roller in a travel direction of the print medium, a transfer roller configured to hold and convey, at a gap between the image carrier and the transfer roller, the print medium passed from the drive roller and the driven roller to transfer the toner image onto a surface of the print medium, and a conveyance suspension unit to stop the drive roller and the driven roller from applying a drive force to the print medium to allow the image carrier and the transfer roller to convey the print medium at a time at which the print medium reaches the gap between the image carrier and the transfer roller and starts to be conveyed by the image carrier and the transfer roller.

According to one embodiment, a method of controlling conveyance of a print medium in an image forming apparatus includes conveying a print medium from an upstream conveyance unit to a rotating image carrier having a toner image formed on a surface thereof, controlling the upstream conveyance unit to stop a drive force for conveying the print medium from being applied from the upstream conveyance unit to the print medium at a time at which the print medium comes in contact with the surface of the image carrier and starts to be conveyed by the image carrier, and conveying the print medium by rotation of the rotating image carrier after the stopping of the drive force.

According to at least one embodiment, an image forming apparatus is provided that can produce a high-quality image by keeping the travel speed of a print medium equal to the surface speed of an image carrier at the time of transferring a toner image to the print medium.

### BRIEF DESCRIPTION OF THE DRAWINGS

Other objects and further features of embodiments will be apparent from the following detailed description when read in conjunction with the accompanying drawings, in which:

FIG. 1 is a drawing illustrating an example of the schematic configuration of an image forming apparatus according to a first embodiment;

FIG. 2 is a drawing illustrating an example of the schematic configuration of a second transfer unit and an upstream conveyance unit according to the first embodiment;

FIG. 3 is a drawing illustrating timing at which an electromagnetic clutch is controlled based on the detection result of a timing sensor according to the first embodiment;

FIG. 4 is a drawing illustrating an example of the schematic configuration of a second transfer unit and an upstream conveyance unit according to a second embodiment;

FIG. 5 is a drawing illustrating timing at which a transfer roller is separated based on the detection result of the timing sensor according to the second embodiment; and

FIG. 6 is a drawing illustrating an example of the schematic configuration of a second transfer unit and an upstream conveyance unit according to a third embodiment.

### DESCRIPTION OF THE PREFERRED EMBODIMENTS

In the following, embodiments will be described by referring to the accompanying drawings. In these drawings, the same elements are referred to by the same references, and a description thereof may be omitted.

### First Embodiment

### <Configuration of Image Forming Apparatus>

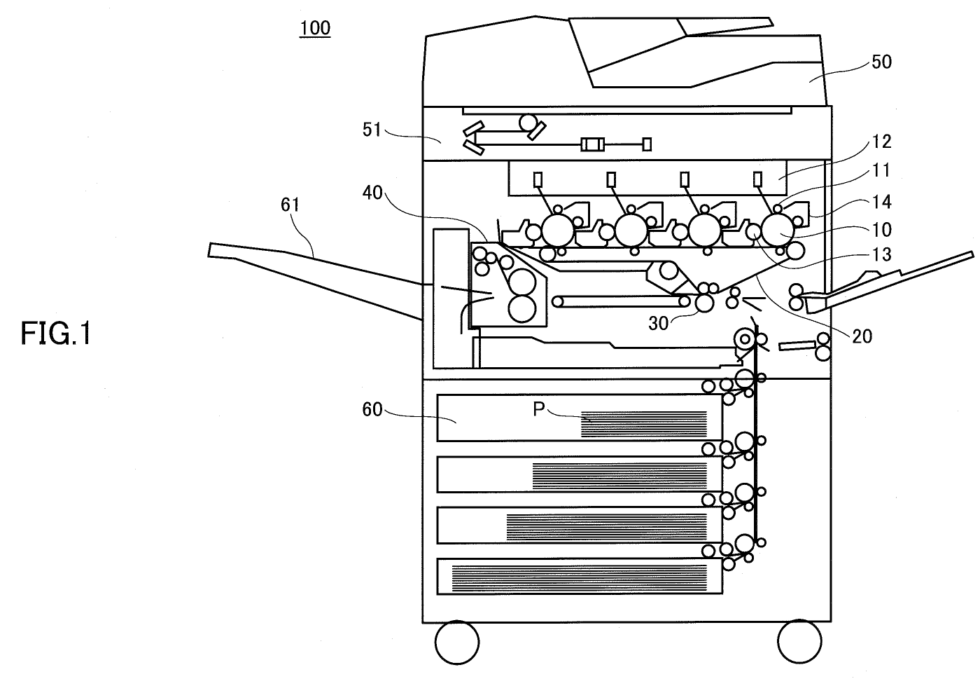

FIG. 1 is a drawing illustrating an example of the schematic configuration of an image forming apparatus 100 according to a first embodiment.

The image forming apparatus 100 includes a photo conductor 10, a charging unit 11, an exposure unit 12, a developing unit 13, an intermediate transfer belt 20, a transfer roller 30, a fuser unit 40, an automatic document feeder 50, and a scanner unit 51. The image forming apparatus 100 is a multifunction device that prints an image on a sheet P serving as a print medium stored in a sheet tray 60.

When the image forming apparatus 100 is to print an image on a sheet P, the charging unit 11 uniformly charges the surface of the photo conductor 10 that is rotating. A document placed in the automatic document feeder 50 is scanned by the scanner unit 51 to produce image data, based on which the exposure unit 12 exposes the surface of the photo conductor 10 to light to create a latent image. The developing unit 13 that has a developing agent stored therein inclusive of toner develops the latent image on the surface of the photo conductor 10 to create a toner image. The image forming apparatus 100 includes a plurality of photo conductors 10 and a plurality of developing units 13 to create toner images of respective colors, which are then superimposed one over another on the intermediate transfer belt 20 that is rotating.

The toner image transferred onto the intermediate transfer belt 20 is further transferred by a second transfer unit situated between the intermediate transfer belt 20 and the transfer roller onto a sheet P supplied from the sheet tray 60. The sheet P having the toner image transferred thereon is conveyed to the fuser unit 40 by which to be heated and pressed to fuse the toner image before being ejected onto a sheet discharge tray 61.

After transferring the toner images to the intermediate transfer belt 20, the photo conductors 10 are cleaned by cleaning units 14 which remove remaining toner from the surfaces of the photo conductors 10. Preparation for a next image forming operation is thus made.

### <Configuration of Second Transfer Unit and Upstream Conveyance Unit>

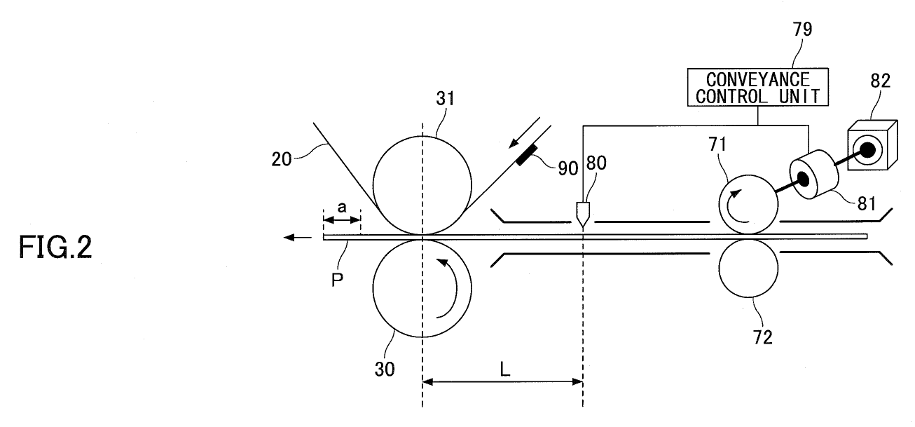

FIG. 2 is a drawing illustrating an example of the schematic configuration of the second transfer unit and an upstream conveyance unit according to the first embodiment.

The sheet P is supplied to a gap between the intermediate transfer belt 20 and the transfer roller 30 at the time at which a toner image 90 on the surface of the rotating intermediate transfer belt 20 reaches the second transfer unit due to the rotation of the intermediate transfer belt 20.

A drive roller 71 is connected to a motor serving as an example of a drive unit via a transmission mechanism, and receives a drive force from the motor 82 to rotate in a direction indicated by an arrow. The transmission mechanism between the drive roller 71 and the motor 82 includes an electromagnetic clutch 81. The electromagnetic clutch 81 is controlled by a conveyance control unit 79 to transmit or not to transmit a drive force from the motor 82 to the drive roller 71.

A driven roller 72 is situated opposite the drive roller 71. The driven roller 72 and the rotating drive roller 71 hold and convey the sheet P placed therebetween. The driven roller 72 rotates to follow the movement of the sheet P while the sheet P is conveyed.

The intermediate transfer belt 20 is a rotatable endless belt that is stretched between a plurality of rollers. The intermediate transfer belt 20 rotates to move the superimposed toner images 90 transferred from the photo conductors 10. The intermediate transfer belt 20 is supported from the inner side thereof by a support roller 31 that is situated opposite the transfer roller 30. The intermediate transfer belt 20 transfers the toner image 90 onto the sheet P that is conveyed to the gap between the support roller 31 and the transfer roller 30.

The transfer roller 30 presses the sheet P against the support roller 31 via the intermediate transfer belt 20 at the time of transferring the toner image 90 onto the sheet P. The transfer roller 30 is rotated by a drive unit (not shown) at the same circumferential speed as the surface speed of the intermediate transfer belt 20.

A torque limiter or the like may be provided in a transmission mechanism situated between the transfer roller 30 and the drive unit for driving the transfer roller 30, so that the circumferential speed of the transfer roller 30 becomes equal to the surface speed of the intermediate transfer belt 20 at the time of transferring a toner image onto the sheep P. The torque of the torque limiter is limited to smaller than the torque created by a physical contact between the intermediate transfer belt 20 and the transfer roller 30. With this arrangement, the transfer roller 30 in contact with the intermediate transfer belt 20 rotates to follow the movement of the intermediate transfer belt 20. At the time of transferring a toner image, thus, the circumferential speed of the transfer roller 30 is kept equal to the surface speed of the intermediate transfer belt 20.

Further, a disconnection mechanism may be provided to separate the transfer roller 30 from the intermediate transfer belt 20 in order to avoid wearing of the surface thereof caused by a physical contact with the intermediate transfer belt 20 when an operation to transfer the toner image 90 onto a sheet P is not being performed.

The distance between the set of the drive roller 71 and the driven roller 72 and the set of the intermediate transfer belt 20 and the transfer roller is set smaller than the length in a conveyance direction of the smallest sheet P on which the image forming apparatus 100 prints an image.

Further, a timing sensor 80, which is an example of a print medium detecting unit, is provided between the set of the drive roller 71 and the driven roller 72 and the set of the intermediate transfer belt 20 and the transfer roller 30.

The timing sensor 80 may be a thru-beam or reflective optical sensor, for example. The timing sensor 80 detects the passing of the head end of a sheet P being conveyed between the set of the drive roller 71 and the driven roller 72 and the set of the intermediate transfer belt 20 and the transfer roller 30. The position of the timing sensor 80 may preferably be set as close to the second transfer unit as possible in order to measure the time at which the sheet P reaches the second transfer unit situated between the intermediate transfer belt 20 and the transfer roller 30.

The conveyance control unit 79 is connected to the timing sensor 80 and to the electromagnetic clutch 81. The conveyance control unit 79 controls the electromagnetic clutch 81 based on the result of detection made by the timing sensor 80, thereby transmitting or disconnecting a drive force from the motor 82 to the drive roller 71. By disconnecting the drive force from the motor 82 to the driver roller 71, the conveyance control unit 79 serves as a conveyance suspension unit to suspend the supply of a conveyance drive force from the drive roller 71 and the driven roller 72 to a sheet P. The conveyance control unit 79 is implemented by the use of a program that is stored in a memory device such as a ROM or RAM and executed by a CPU of the image forming apparatus 100.

### <Sheet Conveyance Control>

In the configuration illustrated in FIG. 2, the conveyance control unit 79 controls the electromagnetic clutch 81 to stop a drive force from being transmitted from the motor 82 to the drive roller 71 at the time at which the sheet P reaches the gap between the intermediate transfer belt 20 and the transfer roller 30 and starts to be conveyed by the intermediate transfer belt 20 and the transfer roller 30. Due to the stopping of transmission of the drive force from the motor 82 to the drive roller 71, the conveyance drive force is stopped from being applied from the drive roller 71 and the driven roller 72 to the sheet P, so that the sheet P is held between and conveyed by the intermediate transfer belt 20 and the transfer roller 30. When this happens, the drive roller 71 and the driven roller 72 holding the rear end of the sheet P at the gap therebetween are rotated by following the movement of the sheet P that is conveyed by the intermediate transfer belt 20 and the transfer roller 30.

This control serves to eliminate the influence of the drive roller 71 on the travel speed of the sheet P at the time of transferring the toner image 90, thereby preventing the degradation of image quality such as displacements of image positions caused by a difference between the travel speed of the sheet P and the surface speed of the intermediate transfer belt 20.

The conveyance control unit 79 detects the time at which the sheet P reaches the gap between the intermediate transfer belt 20 and the transfer roller 30, based on the detection result obtained by the timing sensor 80 detecting the head end of the sheet P, the distance between the timing sensor 80 and the set of the intermediate transfer belt 20 and the transfer roller 30, and the travel speed of the sheet P.

The distance between the timing sensor 80 and the gap between the intermediate transfer belt 20 and the transfer roller 30 is denoted as L, and the travel speed of the sheet P is denoted as v. A time length S1 between the time at which the timing sensor 80 detects the passing of the head end of the sheet P and the time at which the head end of the sheet P reaches the gap between the intermediate transfer belt 20 and the transfer roller 30 is then represented as follows.

S1=L/v (1)

L: distance between the timing sensor 80 and the gap between the intermediate transfer belt 20 and the transfer roller 30

v: travel speed of the sheet P

With the length of the unprintable head margin of the sheet P in the travel direction of the sheet P being denoted as “a”, a time length S2 between the time at which the timing sensor 80 detects the passing of the head end of the sheet P and the time at which the unprintable head margin of the sheet P finishes passing through the gap between the intermediate transfer belt 20 and the transfer roller 30 is represented as follows.

S2=(L+a)/v (2)

a: length of the unprintable had margin of the sheet P in the travel direction

The conveyance control unit 79 controls the electromagnetic clutch 81 to stops a drive force from being transmitted from the motor 82 to the drive roller 71 at the end of a time length T that is between the time length S1 obtained by the formula (1) and the time length S2 obtained by the formula (2).

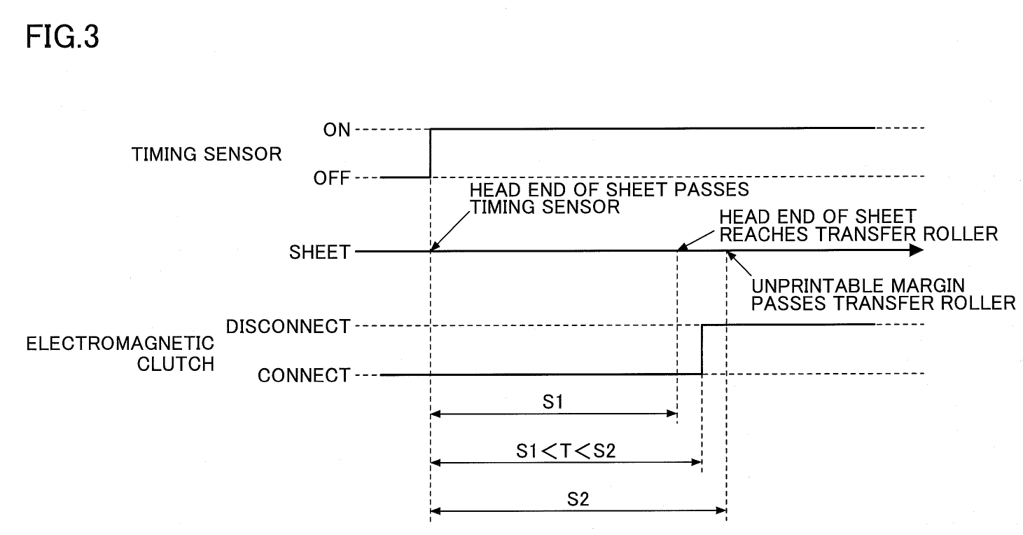

FIG. 3 is a drawing illustrating timing at which the electromagnetic clutch 81 is controlled based on the detection result of the timing sensor 80 according to the first embodiment.

As illustrated in FIG. 3, the conveyance control unit 79 stops a drive force from being transmitted from the motor 82 to the drive roller 71 at the end of the time length T that is between the time length S1 and the time length S2, which are obtained by the formula (1) and the formula (2), respectively. As the drive force is prevented from being transmitted to the drive roller 71, the intermediate transfer belt 20 and the transfer roller can hold the sheet P placed therebetween without being affected by the drive roller 71 at the time of transferring the toner image 90. Accordingly, no difference occurs between the travel speed of the sheet P and the surface speed of the intermediate transfer belt 20 at the time of transferring the toner image 90. A high quality image is thus obtained by transferring the toner image 90 onto the sheet P without creating positional displacements or the like. In the case of duplex printing, high quality images are obtained that are accurately aligned between the front side and the back side.

The image forming apparatus 100 according to the first embodiment is configured to transfer a toner image from the intermediate transfer belt 20 to a sheet P. The disclosed technology is also applicable to an image forming apparatus that transfers a toner image formed on the photo conductor 10 serving as an image carrier to a sheet P at a gap between the photo conductor 10 and a transfer roller. In this case also, the electromagnetic clutch 81 may be controlled to stop a drive force from being transmitted to the drive roller 71 of the upstream conveyance unit at the point in time at which the sheet P reaches the gap between the photo conductor and the transfer roller 30 and starts to be conveyed by the photo conductor 10 and the transfer roller 30. This arrangement keeps the travel speed of the sheet P equal to the circumferential speed of the photo conductor 10 at the time of transferring a toner image. As a result, lowering of image quality caused by the positional misalignment of transferred toner images or the like is prevented, thereby producing a high-quality image.

Further, provision may be made such that the electromagnetic clutch 81 is not provided between the drive roller 71 and the motor 82, and the conveyance control unit 79 switches off the power to the motor 82 at the end of the time length T that is between the time length S1 and the time length S2. In such a case, a DC motor may be used as the motor 82 in order to reduce its effect on the drive roller 71 that rotates by following the movement of the sheet P after the power is switched off.

### Second Embodiment

In the following, a second embodiment will be described with reference to the accompanying drawings. A description will be omitted of the same elements as those of the embodiments already described. The second embodiment differs from the first embodiment in that no electromagnetic clutch is provided between the drive roller 71 and the motor 82, and a separation mechanism is provided that causes the driven roller 72 to move away from the drive roller 71.

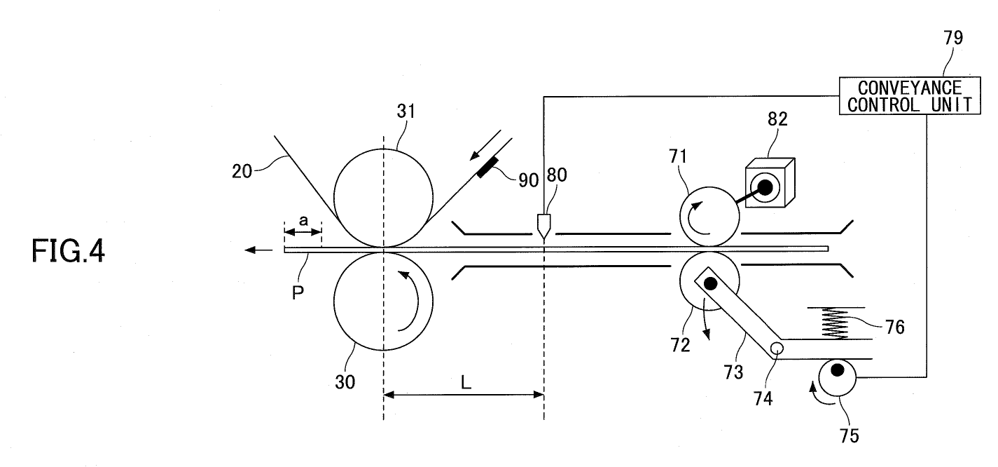

FIG. 4 is a drawing illustrating an example of the schematic configuration of the second transfer unit and an upstream conveyance unit according to the second embodiment.

As illustrated in FIG. 4, the separation mechanism of the driven roller 72 includes a support member 73, a spring 76, and an eccentric cam 75.

The support member 73 supports the rotational shaft of the driven roller 72, and is rotatable about a pivot point 74.

The spring 76 is in contact with the support member 73 on the side of the pivot point 74 opposite the driven roller 72. The spring 76 serves as an urging unit to urge the support member 73 such that the driven roller 72 is brought in contact with the drive roller 71 or is pressed against the drive roller 71 with an intervening paper sheet therebetween.

The eccentric cam 75 is in contact with the support member 73 on the side of the pivot point 74 opposite the driven roller 72. The eccentric cam 75 is rotated by a motor (not shown) controlled by the conveyance control unit 79 to move the support member 73 such that the driven roller 72 is moved away from the drive roller 71.

The conveyance control unit 79 is connected to the timing sensor 80 and to the motor that rotates the eccentric cam 75. When the sheet P reaches the gap between the intermediate transfer belt 20 and the transfer roller 30 and starts to be conveyed by the intermediate transfer belt 20 and the transfer roller 30, the conveyance control unit 79 causes the eccentric cam 75 to rotate to separate the driven roller 72 from the drive roller 71.

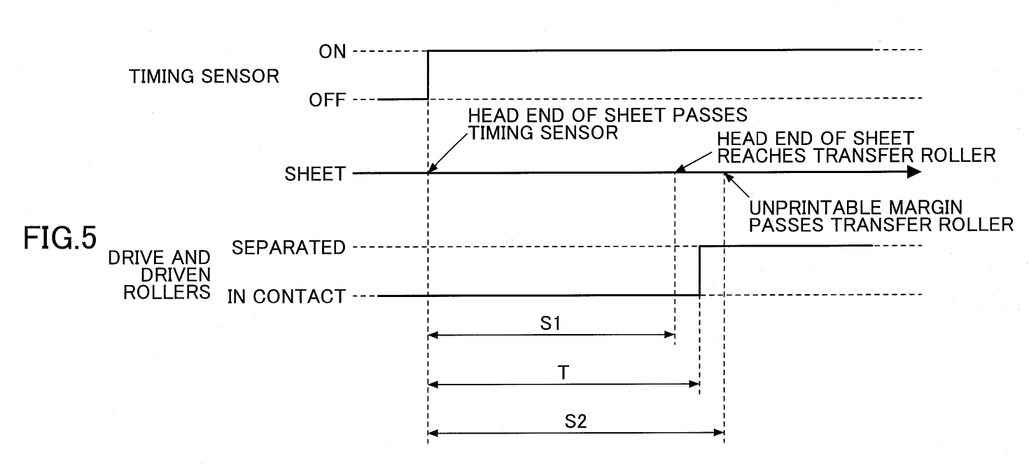

FIG. 5 is a drawing illustrating timing at which the electromagnetic clutch 81 is controlled based on the detection result of the timing sensor 80 according to the second embodiment.

The time length S1 illustrated in FIG. 5 denotes the length of a period between the time at which the sheet P is detected by the timing sensor 80 and the time at which the sheet P reaches the gap between the intermediate transfer belt 20 and the transfer roller 30, and is obtained by use of the equation (1). The time length S2 denotes the length of a period between the time at which the sheet P is detected by the timing sensor 80 and the time at which the unprintable head margin of sheet P finishes passing the gap between the intermediate transfer belt 20 and the transfer roller 30, and is obtained by use of the equation (2).

The conveyance control unit 79 rotates the eccentric cam 75 to rotates the support member 73 at the end of the time length T that is between the time length S1 and the timing length S2, thereby separating the driven roller 72 from the drive roller 71. Upon the separation of the driven roller 72 from the drive roller 71, the sheet P is held and carried by the intermediate transfer belt 20 and the transfer roller 30 without being affected by the drive roller 71. Accordingly, no difference occurs between the travel speed of the sheet P and the surface speed of the intermediate transfer belt 20 at the time of transferring the toner image 90. A high quality image is thus obtained by transferring the toner image 90 onto the sheet P without creating positional displacements or the like. In the case of duplex printing, high quality images that are accurately aligned between the front side and the back side are obtained.

Alternatively, a separation mechanism may be provided that causes the drive roller 71 to move away from the driven roller 72. In this case, a flexible joint, coupling, or the like may be provided at the rotational shaft of the drive roller 71 to be connected to the shaft or a gear of the motor 82 in order to transmit a drive force from the motor 82 to the drive roller 71 that is moved.

### Third Embodiment

In the following, a third embodiment will be described with reference to the accompanying drawings. A description will be omitted of the same elements as those of the embodiments already described. In the third embodiment, the separation mechanism for causing the driven roller 72 to move away from the drive roller 71 has a different configuration than the configuration used in the second embodiment.

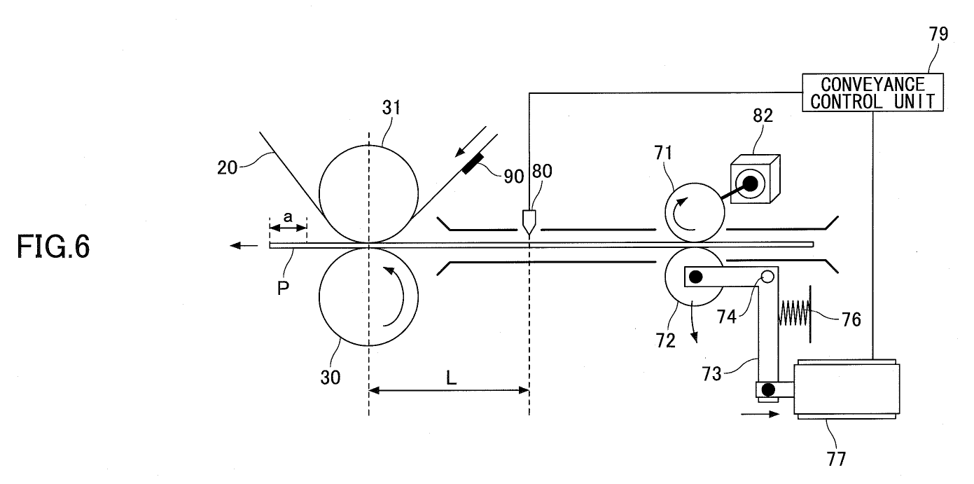

FIG. 6 is a drawing illustrating an example of the schematic configuration of the second transfer unit and an upstream conveyance unit according to the third embodiment.

As illustrated in FIG. 6, the separation mechanism of the driven roller 72 includes the support member 73, the spring 76, and a solenoid 77.

The support member 73 supports the rotational shaft of the driven roller 72, and is rotatable about a pivot point 74.

The spring 76 is in contact with the support member 73 on the side of the pivot point 74 opposite the driven roller 72. The spring 76 serves as an urging unit to urge the support member 73 such that the driven roller 72 is brought in contact with the drive roller 71 or is pressed against the drive roller 71 with an intervening paper sheet therebetween.

The solenoid 77 is controlled by the conveyance control unit 79 to rotate the support member 73, thereby moving the driven roller 72 away from the drive roller 71.

The conveyance control unit 79 is connected to the timing sensor 80 and to the solenoid 77. When the sheet P reaches the gap between the intermediate transfer belt 20 and the transfer roller 30 and starts to be conveyed by the intermediate transfer belt 20 and the transfer roller 30, the conveyance control unit 79 causes the solenoid 77 to rotate the support member 73 to separate the driven roller 72 from the drive roller 71.

As illustrated in FIG. 5, the conveyance control unit 79 causes the solenoid 77 to rotate the support member 73 at the end of the time length T that is between the time length S1 and the timing length S2, thereby separating the driven roller 72 from the drive roller 71. Upon the separation of the driven roller 72 from the drive roller 71, the sheet P is held and carried by the intermediate transfer belt 20 and the transfer roller 30 without being affected by the drive roller 71. Accordingly, no difference occurs between the travel speed of the sheet P and the surface speed of the intermediate transfer belt 20 at the time of transferring the toner image 90. A high quality image is thus obtained by transferring the toner image 90 onto the sheet P without creating positional displacements or the like. In the case of duplex printing, high quality images that are accurately aligned between the front side and the back side are obtained.

Alternatively, a separation mechanism may be provided that causes the drive roller 71 to move away from the driven roller 72. In this case, a flexible joint, coupling, or the like may be provided at the rotational shaft of the drive roller 71 to be connected to the shaft or a gear of the motor 82 in order to transmit a drive force from the motor 82 to the drive roller 71 that is moved.

Although the present invention has been described heretofore by referring to one or more embodiments, the present invention is not limited to such embodiments. Various variations and modifications may be made without departing from the scope of the present invention.

The present application is based on Japanese priority applications No. 2012-067670 filed on Mar. 23, 2012 and No. 2013-046281 filed on Mar. 8, 2013, with the Japanese Patent Office, the entire contents of which are hereby incorporated by reference.

What is claimed is:

1. An image forming apparatus, comprising:
a drive roller configured to rotate;
a driven roller configured to hold and convey a print medium at a gap between the drive roller and the driven roller;
an image carrier configured to have a toner image formed on a surface thereof and to rotate, the image carrier being situated downstream relative to the drive roller and the driven roller in a travel direction of the print medium;
a transfer roller configured to hold and convey, at a gap between the image carrier and the transfer roller, the print medium passed from the drive roller and the driven roller to transfer the toner image onto a surface of the print medium; and
a conveyance suspension unit to stop the drive roller and the driven roller from applying a drive force to the print medium to allow the image carrier and the transfer roller to convey the print medium at a time at which the print medium reaches the gap between the image carrier and the transfer roller and starts to be conveyed by the image carrier and the transfer roller.

2. The image forming apparatus as claimed in claim 1, further comprising a print medium detecting unit configured to detect passage of the print medium at a position between the drive roller and the image carrier, wherein the conveyance suspension unit is configured to determine a time at which the print medium reaches the gap between the image carrier and the transfer roller and starts to be conveyed by the image carrier and the transfer roller, based on a result of detection of the print medium by the print medium detecting unit, a distance between the print medium detecting unit and the gap between the image carrier and the transfer roller, and a travel speed of the print medium conveyed by the drive roller and the driven roller.

3. The image forming apparatus as claimed in claim 1, further comprising:
a drive unit configured to rotate the drive roller; and
an electromagnetic clutch situated in a path for transmitting a drive force of the drive unit to the drive roller, the electromagnetic clutch being configured to transmit or not to transmit the drive force,
wherein the conveyance suspension unit is configured to control the electromagnetic clutch to stop the drive force from being transmitted at the time at which the print medium reaches the gap between the image carrier and the transfer roller and starts to be conveyed by the image carrier and the transfer roller.

4. The image forming apparatus as claimed in claim 1, further comprising a separation mechanism configured to move one of the drive roller and the driven roller away from another one of the driver roller and the driven roller, wherein the conveyance suspension unit is configured to control the separation unit to separate the drive roller and the driven roller from each other at the time at which the print medium reaches the gap between the image carrier and the transfer roller and starts to be conveyed by the image carrier and the transfer roller.

5. The image forming apparatus as claimed in claim 4, wherein the separation mechanism includes:
a support member configured to support a rotational shaft of one of the drive roller and the driven roller, and configured to be rotatable about a pivot point;
an urging unit configured to urge the support member such that the drive roller and the driven roller are brought in contact with each other; and
an eccentric cam configured to be in contact with the support member and to rotate to move the support member such that the drive roller and the driven roller are separated from each other.

6. The image forming apparatus as claimed in claim 4, wherein the separation mechanism includes:
a support member configured to support a rotational shaft of one of the drive roller and the driven roller, and configured to be rotatable about a pivot point;
an urging unit configured to urge the support member such that the drive roller and the driven roller are brought in contact with each other; and
a solenoid configured to move the support member such that the drive roller and the driven roller are separated from each other.

7. A method of controlling conveyance of a print medium in an image forming apparatus, comprising:
conveying a print medium from an upstream conveyance unit to a rotating image carrier having a toner image formed on a surface thereof;
controlling the upstream conveyance unit to stop a drive force for conveying the print medium from being applied from the upstream conveyance unit to the print medium at a time at which the print medium comes in contact with the surface of the image carrier and starts to be conveyed by the image carrier; and
conveying the print medium by rotation of the rotating image carrier after the stopping of the drive force.

8. The method as claimed in claim 7, further comprising detecting a passage of a head end of the print medium at a position between the upstream conveyance unit and the image carrier, wherein the step of controlling the upstream conveyance unit stops the drive force at timing responsive to the detection of the passage of the head end of the print medium.
